(19) United States
(12) Patent Application Publication
(10) Pub. No.: US 2025/0375975 A1
(43) Pub. Date: Dec. 11, 2025

(54) RECORDING APPARATUS

(71) Applicant: SEIKO EPSON CORPORATION, TOKYO (JP)

(72) Inventors: Koji HARA, MATSUMOTO-SHI (JP); Shintaro KOMURO, MATSUMOTO-SHI (JP); Masaki SHIMOMURA, MATSUMOTO-SHI (JP); Hiroyuki MAEDA, MATSUMOTO-SHI (JP); Masato OGAWA, SHIOJIRI-SHI (JP); Hiroshi SHIOBARA, MATSUMOTO-SHI (JP); Yuki HARA, SHIOJIRI-SHI (JP); Koki MURAKAMI, KISO-GUN AGEMATSU-MACHI (JP)

(21) Appl. No.: 19/232,918

(22) Filed: Jun. 10, 2025

(30) Foreign Application Priority Data
Jun. 10, 2024 (JP) 2024-093624

(51) Int. Cl. B41J 29/17; B41J 2/17; B41J 11/00; B41J 29/377; B65H 5/02

(52) U.S. Cl. CPC B41J 29/17; B41J 2/1714; B41J 11/007; B41J 29/377; B65H 5/021; B65H 2301/531; B65H 2801/06

(57) ABSTRACT

The recording apparatus includes a recording unit configured to perform recording on a medium, a support unit capable of supporting the medium, a moving unit configured to move the support unit between a first position facing the recording unit and a second position separated from the recording unit, and an air flow generation unit configured to generate at least an ejection air flow in a direction from the recording unit toward a position of the support unit present at the first position in a period in which the support unit moves toward the first position or the second position.

The present application is based on, and claims priority from JP Application Serial Number 2024-093624, filed Jun. 10, 2024, the disclosure of which is hereby incorporated by reference herein in its entirety.

### BACKGROUND

### 1. Technical Field

The present disclosure relates to a recording apparatus.

### 2. Related Art

As disclosed in JP-A-2017-77960, there has been known a printing apparatus serving as a recording apparatus in which a conveyance belt facing a printing unit serving as a recording unit rotates by 90 degrees.

JP-A-2017-77960 is an example of the related art.

However, in the recording apparatus explained above, when a support unit including the conveyance belt moves, there is a concern that foreign matters such as paper dust adhere to the recording unit to cause a malfunction.

### SUMMARY

A recording apparatus includes: a recording unit configured to perform recording on a medium; a support unit capable of supporting the medium; a moving unit configured to move the support unit between a first position facing the recording unit and a second position separated from the recording unit; and an air flow generation unit configured to generate at least an ejection air flow in a direction from the recording unit toward a position of the support unit present at the first position in a period in which the support unit moves toward the first position or the second position.

### BRIEF DESCRIPTION OF THE DRAWINGS

FIG. 1 is a cross-sectional view illustrating a configuration of a recording apparatus at the time when recording is performed on a medium.

FIG. 2 is a cross-sectional view illustrating a configuration of the recording apparatus at the time when a maintenance unit covers a liquid discharge surface of a recording unit.

FIG. 3 is a cross-sectional view mainly illustrating an air flow generation unit according to a first embodiment.

FIG. 4 is a cross-sectional view mainly illustrating an air flow generation unit according to a second embodiment at the time when a support unit separates from a recording unit.

FIG. 5 is a cross-sectional view mainly illustrating the air flow generation unit according to the second embodiment at the time when the support unit approaches the recording unit.

FIG. 6 is a cross-sectional view mainly illustrating an air flow generation unit according to a third embodiment at the time of recording.

FIG. 7 is a cross-sectional view mainly illustrating the air flow generation unit according to the third embodiment at the time when third dust of a belt is sucked.

### DESCRIPTION OF EMBODIMENTS

A recording apparatus 1 is explained with reference to the drawings. Note that directions in the drawings are explained using a three-dimensional coordinate system. For convenience of explanation, a positive direction of a Z axis is referred to as upward direction, above, or simply as up, a negative direction of the Z axis is referred to as downward direction, below, or simply as down, a positive direction of an X axis is referred to as rightward direction, rightward, or simply as right, a negative direction of the X axis is referred to as leftward direction, leftward, or simply as left, a positive direction of a Y axis is referred to as forward direction, forward, or simply as front, and a negative direction of the Y axis is referred to as rearward direction, rearward, or simply as rear.

### 1. Configuration of a Recording Apparatus

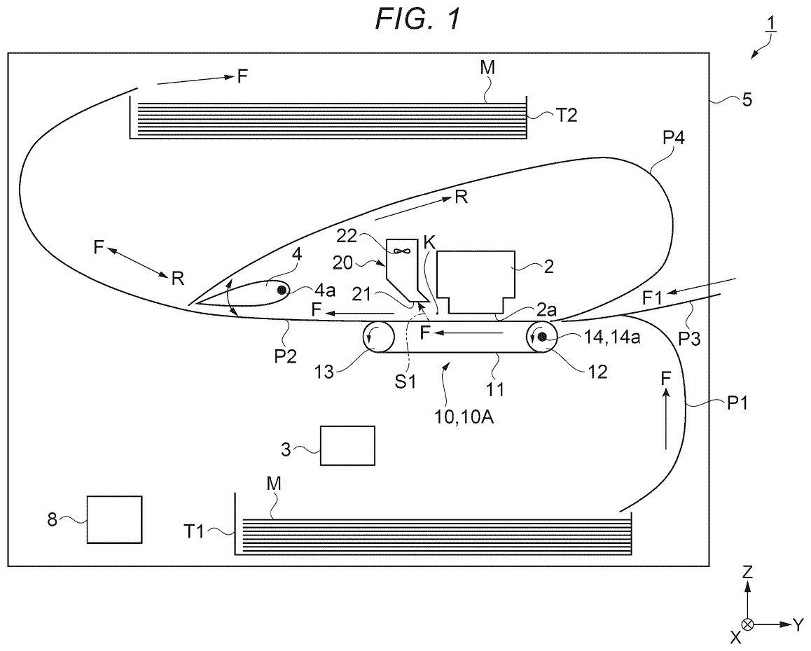

As illustrated in FIG. 1, a recording apparatus 1 includes a head 2, which is a recording unit. The head 2 is, for example, a line-type inkjet head extending in the left-right direction.

The head 2 is a liquid discharge unit and discharges ink, which is liquid, from an ink discharge surface 2a, which is a liquid discharge surface. The head 2 discharges the ink from above onto a medium M supported from below by a support unit 10 and performs recording. At this time, as explained below, the support unit 10 is located at a first position 10A and faces the head 2.

The recording apparatus 1 includes a plurality of paths for conveying the medium M. For convenience of illustration, in the figures, the medium M conveyed on the respective paths is omitted.

The recording apparatus 1 includes one path for the medium M, the path extending along a conveyance direction F of the medium M. In the recording apparatus 1, a paper feed tray T1, which is a paper feed unit, a first path P1, the head 2, a duct 20, which is an air flow generation unit, a support unit 10 capable of facing the head 2 and the duct 20, a second path P2, and a paper discharge tray T2, which is a paper discharge unit, are disposed from upstream to downstream in the conveyance direction F of the path.

When the medium M is conveyed in the conveyance direction F and reaches a part between the head 2 and the support unit 10, the front side, which is one surface, of the medium M is recorded by the head 2.

The recording apparatus 1 also includes a third path P3, which is another path for the medium M and supplies the medium M from the front of the case 5 toward a manual feed direction F1. An operator inserts the medium M into the third path P3 in the manual feed direction F1. The third path P3 communicates with the first path P1. After the medium M is conveyed from the third path P3 to the first path P1, the medium M is conveyed in the conveyance direction F explained above.

A branch section 4 is disposed halfway in the second path P2. The branch section 4 is rotatable centering on a branch shaft 4a. The branch section 4 rotates clockwise centering on the branch shaft 4a in advance. The branch section 4 that has rotated clockwise enables the medium M, which has been recorded on the front side, to smoothly pass through the branch section 4 in the second path P2 from the leading end in the conveyance direction F.

When the trailing end of the medium M conveyed along the second path P2 passes through the branch section 4, the conveyance of the medium M is temporarily stopped. The branch section 4 rotates counterclockwise centering on the branch shaft 4a.

In this state, when the medium M is conveyed in a reverse direction R, which is a direction opposite to the conveyance direction F, the medium M is guided by the branch section 4 from the trailing end and is conveyed along a fourth path P4 that branches upward from the second path P2. The recording apparatus 1 may include a switchback path parallel to the second path P2 and convey the medium M in the reverse direction R.

The fourth path P4 is curved and communicates with the first path P1 below. The medium M conveyed from the fourth path P4 to the first path P1 is reversed. Thereafter, the medium M is conveyed in the conveyance direction F explained above. The medium M is recorded on a back side, which is the other side, by the head 2. As explained above, the medium M can be recorded on both sides, with the front side being recorded first, then reversed and recorded on the back side.

A plurality of conveyance rollers (not illustrated) are respectively provided in the first path P1, the second path P2, the third path P3, and the fourth path P4 to enable the medium M to be conveyed.

The support unit 10 includes a belt 11, which is a conveyance belt, a first roller 12, a second roller 13, a rotating unit 14, which is a moving unit, and a rotating shaft 14a.

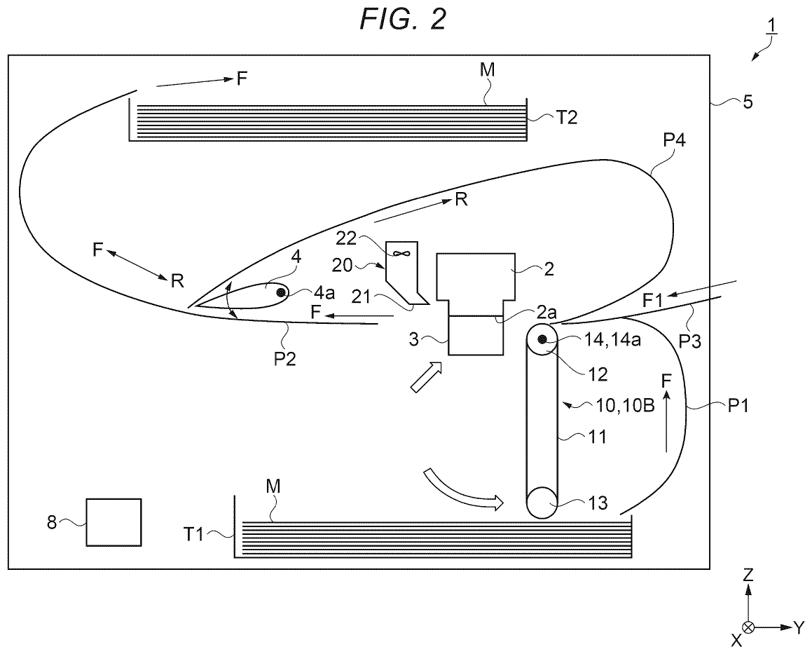

The rotating unit 14 can move the support unit 10 between a first position 10A facing the head 2 illustrated in FIG. 1 and a second position 10B separated from the head 2 illustrated in FIG. 2. The first position 10A is also a conveyance position where the support unit 10 is capable of conveying the medium M. The second position 10B is also a retracted position where the support unit 10 is retracted from the head 2.

The support unit 10 also includes, for example, a roller motor (not illustrated) that rotates the first roller 12. In this case, the first roller 12 is a driving roller driven by the roller motor and the second roller 13 is a driven roller that rotates in association with the first roller 12.

The support unit 10 rotates the first roller 12 and the second roller 13 with the roller motor. The belt 11, which is an endless belt, is stretched between the first roller 12 and the second roller 13 and is configured to turn around. The first roller 12 and the second roller 13 rotate counterclockwise and the belt 11 turns around counterclockwise, whereby the support unit 10 can convey the medium M on the belt 11 in the conveyance direction F.

The duct 20 includes a fan 22, which is an air blowing unit, and an air flow port 21. The duct 20 also includes a fan motor (not illustrated) that rotates the fan 22.

The duct 20 can cause the fan 22 to rotate in one direction, for example, cause the fan 22 to rotate forward with the fan motor and can cause the fan 22 to function as a suction, which is an intake unit that sucks air from the air flow port 21. The duct 20 can also cause the fan 22 to rotate in the other direction, for example, cause the fan 22 to reversely rotate with the fan motor and can cause the fan 22 to function as a blower, which is an exhaust unit that blows out air from the air flow port 21.

As explained above, by switching the operation of the fan 22, the duct 20 can have suction and blower functions.

When the head 2 discharges ink to perform recording on the medium M, an ink mist K, which is mist of small liquid particles and small ink particles, sometimes occurs near the ink discharge surface 2a and floats in the air. By functioning as the suction, the duct 20 can generate a first suction air flow S1 and suck and remove the ink mist K.

As illustrated in FIG. 1, when the support unit 10 is present at the first position 10A, the duct 20 is located above the support unit 10. When the support unit 10 is present at the first position 10A, the belt 11 on the upper side of the support unit 10 is capable of supporting the medium M and faces the ink discharge surface 2a of the head 2 and the air flow port 21 of the duct 20.

When the support unit 10 is present at the first position 10A, a maintenance unit 3 is present at a position retracted from the head 2 and the support unit 10.

On the other hand, as explained below with reference to FIG. 2, when the support unit 10 moves to the second position 10B separated from the head 2, the maintenance unit 3 can move toward the head 2.

The support unit 10 is rotatable centering on a rotating shaft 14a by the rotating unit 14. The rotating unit 14 includes a rotating unit motor (not illustrated) and can rotate the support unit 10. The support unit 10 can be rotated counterclockwise centering on the rotation shaft 14a by the rotating unit 14 and move from the first position 10A illustrated in FIG. 1 to the second position 10B illustrated in FIG. 2.

At this time, the support unit 10 separates from the head 2 and the duct 20. Specifically, the belt 11 of the support unit 10 moves away from the ink discharge surface 2a of the head 2 and the air flow port 21 of the duct 20 that the belt 11 faces.

The support unit 10 can also be reversely rotated by the rotating unit 14 and can also move from the second position 10B to the first position 10A.

As illustrated in FIG. 2, when the support unit 10 moves from the first position 10A to the second position 10B, the maintenance unit 3 moves toward the head 2. The maintenance unit 3 includes, for example, a link mechanism (not illustrated). The maintenance unit 3 can move the maintenance unit 3 by driving the link mechanism with a maintenance moving motor (not illustrated).

When the support unit 10 moves to the second position 10B, the medium M is not conveyed. However, in FIG. 2, for comparison with FIG. 1, the conveyance direction F, the reverse direction R, and the like are illustrated in the same manner as in FIG. 1.

The maintenance unit 3 includes at least any one of a cap that covers the ink discharge surface 2a, an ink suction mechanism that sucks ink from the ink discharge surface 2a, and a wiper blade that wipes the ink discharge surface 2a.

The maintenance unit 3 having moved toward the head 2 can cause at least any one of the cap, the ink suction mechanism, and the wiper blade to operate, perform at least any one of capping, flushing, ink suction, wiping, and the like, and perform maintenance of the head 2.

With the maintenance unit 3, the head 2 can prevent a malfunction in discharging ink and recover from the malfunction.

When the support unit 10 moves to the second position 10B, the operator can perform maintenance of the support unit 10, for example, clean the belt 11 of the support unit 10.

The recording apparatus 1 includes a control unit 8 mounted on a control board. The control unit 8 comprehensively controls the units of the recording apparatus 1. The control unit 8 includes a central processing unit (CPU). The CPU is also referred to as processor.

The control unit 8 includes memories such as a flash read only memory (ROM), which is a rewritable nonvolatile memory, and a random access memory (RAM), which is a volatile memory.

The control unit 8 reads a program stored in the flash ROM and executes various kinds of processing using the RAM as a work area. Specifically, for example, the control unit 8 can also control the head 2 to discharge ink and control actuators such as respective motors provided in the units of the recording apparatus 1.

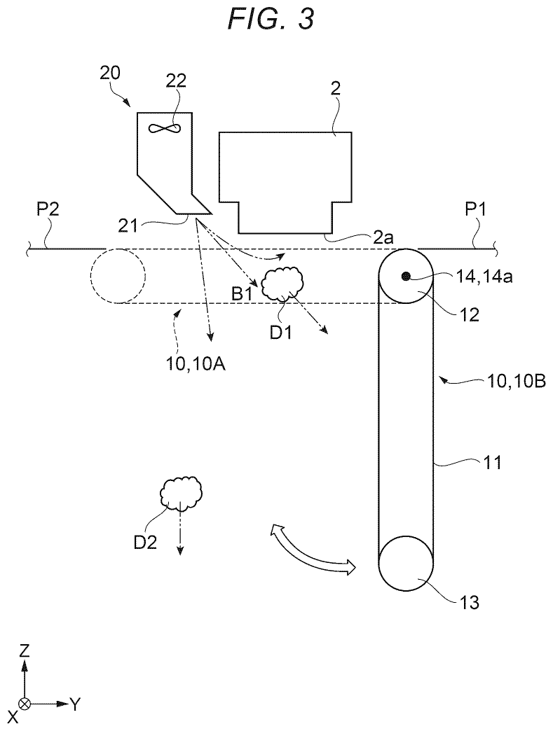

Incidentally, in a case 5 (not illustrated in FIGS. 3 to 7) of the recording apparatus 1, there is dust that is foreign matters such as paper dust caused by the medium M or powder dust entering from the periphery of the recording apparatus 1. When the dust adheres to the head 2, a malfunction such as failure in correct recording sometimes occurs.

For convenience of explanation, as typical dust in the case 5, as illustrated in FIGS. 3 to 5, first dust D1 floating in the air in the case 5 and second dust D2 accumulated in a lower portion in the case 5 are illustrated as examples.

### 2. Air Flow Generation Unit According to the First Embodiment

An example is explained in which the duct 20 according to the first embodiment illustrated in FIG. 3 functions as a blower that blows off such dust not to adhere to the head 2.

First, a case in which the support unit 10 rotates counterclockwise centering on the rotation shaft 14a and moves from the first position 10A to the second position 10B is explained.

The support unit 10 separates from the head 2 to open from the second roller 13 side centering on the rotation shaft 14a. The second roller 13 side of the support unit 10 descends from an upper position while drawing an arc.

A negative pressure of air is generated between the support unit 10 and the head 2 that separate from each other. The surrounding air is drawn by the negative pressure of the air and the first dust D1 near the head 2 is also drawn and sometimes rises and scatters.

At this time, the first dust D1 sometimes rises and scatters toward the ink discharge surface 2a of the head 2. When the first dust D1 adheres to the ink discharge surface 2a, a malfunction such as ink discharge failure is likely to occur.

Thus, when the support unit 10 moves from the first position 10A to the second position 10B, the duct 20 functions as a blower. That is, the duct 20 generates a first ejection air flow B1 and ejects air from the air flow port 21 toward the first dust D1.

The first ejection air flow B1 is preferably at least ejected in a direction including a direction from the head 2 toward the position of the support unit 10 at the first position 10A before moving. Further, the first ejection air flow B1 is preferably at least ejected, through the ink discharge surface 2a of the head 2, in a direction including at least a direction toward the position of the belt 11 of the support unit 10 at the first position 10A before moving.

As illustrated in FIG. 3, the first ejection air flow B1 can move the first dust D1, which is about to rise and scatter toward the ink discharge surface 2a of the head 2, away from the ink discharge surface 2a. In this example, the first dust D1 is moved in a front downward direction by the first ejection air flow B1.

As explained above, in a period in which the support unit 10 moves from the first position 10A to the second position 10B, the duct 20 can prevent, with the first ejection air flow B1, the first dust D1 from moving to the ink discharge surface 2a of the head 2 and can prevent occurrence of a malfunction of the head 2.

The duct 20 may continuously generate the first ejection air flow B1 even after the support unit 10 reaches the second position 10B following the period in which the support unit 10 moves from the first position 10A to the second position 10B. The duct 20 may stop the generation of the first ejection air flow B1 when the support unit 10 reaches the second position 10B.

When the support unit 10 moves to the second position 10B, the duct 20 can also prevent, with the first ejection air flow B1, besides the first dust D1, the second dust D2 from moving to the ink discharge surface 2a of the head 2. The same applies to dust other than the first dust D1 and the second dust D2.

Subsequently, a case in which the support unit 10 rotates clockwise centering on the rotation shaft 14a and moves from the second position 10B to the first position 10A is explained.

At this time, the support unit 10 approaches the head 2 to close from the second roller 13 side centering on the rotation shaft 14a. The second roller 13 side of the support unit 10 rises from a lower position while drawing an arc. As the second roller 13 side of the support unit 10 rises, the second dust D2 accumulated in the lower portion in the case 5 is sometimes fanned to rise and scatter.

At this time, the second dust D2 sometimes rises and scatters toward the ink discharge surface 2a of the head 2. When the second dust D2 adheres to the ink discharge surface 2a, a malfunction such as ink ejection failure is likely to occur.

Thus, when the support unit 10 moves from the second position 10B to the first position 10A, the duct 20 functions as a blower. That is, the duct 20 generates the first ejection air flow B1 explained above and ejects air from the air flow port 21 toward the second dust D2.

The first ejection air flow B1 can move the second dust D2, which is about to rise and scatter toward the ink discharge surface 2a of the head 2, away from the ink discharge surface 2a. In this example, the second dust D2 is moved downward by the first ejection air flow B1.

As explained above, in a period in which the support unit 10 moves from the second position 10B to the first position 10A, the duct 20 can prevent, with the first ejection air flow B1, the second dust D2 from moving to the ink discharge surface 2a of the head 2 and prevent occurrence of a malfunction of the head 2.

When the support unit 10 moves to the first position 10A, the first ejection air flow B1 is preferably at least ejected in a direction including a direction from the head 2 toward the position of the support unit 10 present at the first position 10A. Further, the first ejection air flow B1 is preferably at least ejected, through the ink discharge surface 2a of the head 2, in a direction including a direction toward the position of the belt 11 of the support unit 10 present at the first position 10A.

When the support unit 10 moves to the first position 10A, the duct 20 can prevent, with the first ejection air flow B1, dust including the first dust D1 besides the second dust D2 from moving to the ink discharge surface 2a of the head 2. The same applies to dust other than the first dust D1 and the second dust D2.

The duct 20 may continuously generate the first ejection air flow B1 even after the support unit 10 reaches the first position 10A following the period in which the support unit 10 moves from the second position 10B to the first position 10A.

The duct 20 may stop the generation of the first ejection air flow B1 when the support unit 10 reaches the first position 10A. The duct 20 may stop the generation of the first ejection air flow B1 immediately before the head 2 starts recording.

When the support unit 10 is present at the first position 10A illustrated in FIG. 1, the duct 20 generates the first suction air flow S1 and sucks the ink mist K that occurs when the head 2 discharges ink.

On the other hand, when the support unit 10 moves upward or downward as illustrated in FIG. 3, the duct 20 can switch the operation of the fan 22 to generate the first ejection air flow B1 and move the first dust D1 and the second dust D2 away from the head 2.

The duct 20 is capable of switching at least the generation of the first suction air flow S1 and the first ejection air flow B1.

As explained above, when the support unit 10 moves toward the first position 10A or the second position 10B, the duct 20 generates at least the first ejection air flow B1 in a direction from the head 2 toward the support unit 10 at the first position 10A.

When the support unit 10 moves to the second position 10B and when the support unit 10 moves to the first position 10A, the duct 20 generates the same first ejection air flow B1. When the support unit 10 changes a moving direction, the rotating speed of the fan 22 by the fan motor may be changed to change the strength of an air flow to be ejected.

### 3. Air Flow Generation Unit According to a Second Embodiment

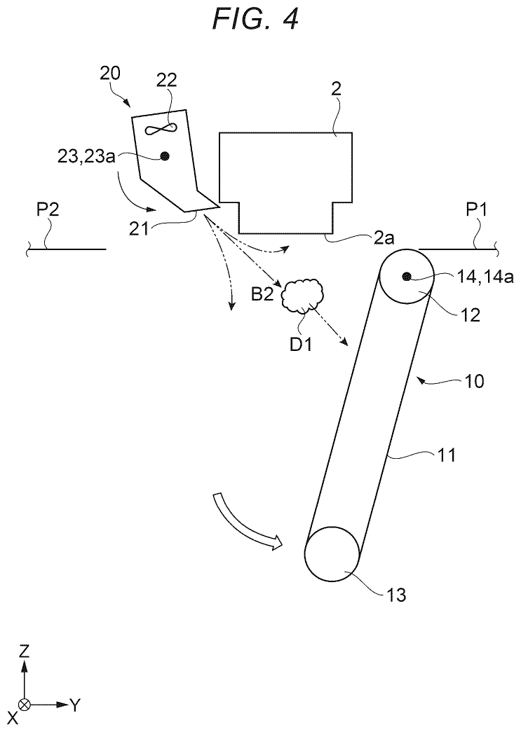

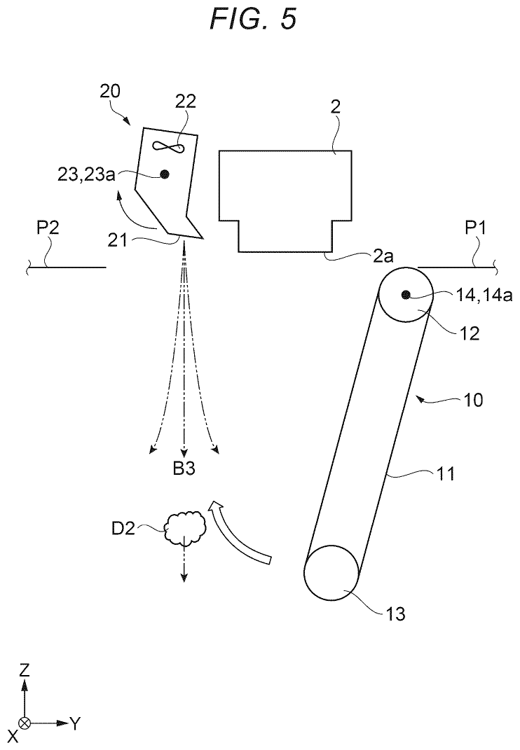

The duct 20 according to a second embodiment illustrated in FIGS. 4 and 5 functions as a blower that ejects a second ejection air flow B2 and a third ejection air flow B3 from the air flow port 21 and is illustrated as an example that can change a wind direction, which is an ejecting direction.

In the following explanation of the second embodiment, differences from the first embodiment explained above are mainly explained. In FIGS. 4 and 5, illustration of the support unit 10 present at the first position 10A is omitted. However, the support unit 10 is at the same position as the position illustrated in FIG. 3.

As illustrated in FIGS. 4 and 5, the duct 20 includes an air flow port moving unit 23 and can rotate centering a duct shaft 23a. The air flow port moving unit 23 can rotate the duct 20 centering on the duct shaft 23a with an air flow port moving motor (not illustrated) to change the direction of the air flow port 21.

The second embodiment is explained below in the same order as the order in the first embodiment.

First, as illustrated in FIG. 4, a case in which the support unit 10 moves from the first position 10A to the second position 10B is explained.

At this time, the duct 20 is rotated counterclockwise at a predetermined angle centering on the duct shaft 23a by the air flow port moving unit 23. Compared with the case of the first embodiment explained above, the air flow port 21 of the duct 20 can move further forward and toward the side of the ink discharge surface 2a of the head 2. At this angle, the duct 20 ejects the second ejection air flow B2 from the air flow port 21.

As illustrated in FIG. 4, the direction in which the duct 20 rotates at predetermined angle counterclockwise and ejects the second ejection air flow B2 is also a direction that is a forward direction relatively to a direction in which the duct 20 ejects the third ejection air flow B3 illustrated in FIG. 5 explained below and is a direction toward the upstream side in the conveyance direction F.

As a result, the second ejection air flow B2 ejected from the air flow port 21 can more strongly eject more air toward the ink discharge surface 2a of the head 2 compared with the first ejection air flow B1 in the first embodiment. The second ejection air flow B2 can more effectively blow off the first dust D1 near the head 2.

As explained above, in the period in which the support unit 10 moves from the first position 10A to the second position 10B, the duct 20 can change the wind direction of the second ejection air flow B2 with the air flow port moving unit 23 and can more effectively move the first dust D1 away from the ink discharge surface 2a of the head 2.

That is, the duct 20 can change the wind direction of the second ejection air flow B2 with the air flow port moving unit 23 and more effectively prevent the first dust D1 from adhering to the ink discharge surface 2a of the head 2.

Subsequently, a case in which the support unit 10 moves from the second position 10B to the first position 10A as illustrated in FIG. 5 is explained.

At this time, the duct 20 is rotated clockwise at a predetermined angle centering on the duct shaft 23a by the air flow port moving unit 23. Compared to the case in the first embodiment explained above, the air flow port 21 of the duct 20 can move further rearward and further to the second roller 13 side of the rising support unit 10. At this angle, the duct 20 ejects the third ejection air flow B3 from the air flow port 21.

As illustrated in FIG. 5, the direction in which the duct 20 rotates clockwise at a predetermined angle to eject the third ejection air flow B3 is also a direction that is a rearward direction relatively to a direction in which the duct 20 ejects the second ejection air flow B2 illustrated in FIG. 4 explained above and is a direction toward the downstream side in the conveyance direction F.

As a result, the third ejection air flow B3 ejected from the air flow port 21 can more strongly eject more air toward the second roller 13 side of the support unit 10 than the first ejection air flow B1 in the first embodiment. The third ejection air flow B3 can more effectively blow off the second dust D2 that is about to rise from the lower portion of the case 5.

As explained above, in the period in which the support unit 10 moves from the second position 10B to the first position 10A, the duct 20 can change the wind direction of the third ejection air flow B3 with the air flow port moving unit 23 and more effectively move the second dust D2 away from the ink discharge surface 2a of the head 2.

That is, the duct 20 can change the wind direction of the third ejection air flow B3 with the air flow port moving unit 23 and more effectively prevent the second dust D2 from adhering to the ink discharge surface 2a of the head 2.

As explained above, when the support unit 10 moves to the second position 10B, the duct 20 changes, with the air flow port moving unit 23, the direction of the air flow port 21 to the upstream side in the conveyance direction F, which is the head 2 side and is the forward direction, and generates the second ejection air flow B2.

On the other hand, when the support unit 10 moves to the first position 10A, the duct 20 changes, with the air flow port moving unit 23, the direction of the air flow port 21 to the downstream side in the conveyance direction F, which is the belt 11 side of the support unit 10 present at the first position 10A and is the rearward direction, and generates the third ejection air flow B3.

That is, the air flow port moving unit 23 changes the direction of the air flow port 21 from the direction toward the position of the support unit 10 present at the first position 10A to the direction toward the head 2 in the period in which the support unit 10 moves from the first position 10A to the second position 10B.

On the other hand, the air flow port moving unit 23 changes the direction of the air flow port 21 from the direction toward the head 2 to the direction toward the position of the support unit 10 present at the first position 10A in the period in which the support unit 10 moves from the second position 10B to the first position 10A.

When changing the moving direction, the support unit 10 may change the direction of the air flow port 21 with the air flow port moving unit 23 and change the rotating speed of the fan 22 by the fan motor to change the air flow strength of the second ejection air flow B2 and the air flow strength of the third ejection air flow B3. The air flow strength of the second ejection air flow B2 and the air flow strength of the third ejection air flow B3 may be the same.

The duct 20 can switch at least the generation of the first suction air flow S1 and one of the second ejection air flow B2 and the third ejection air flow B3.

### 4. Air Flow Generation Unit According to a Third Embodiment

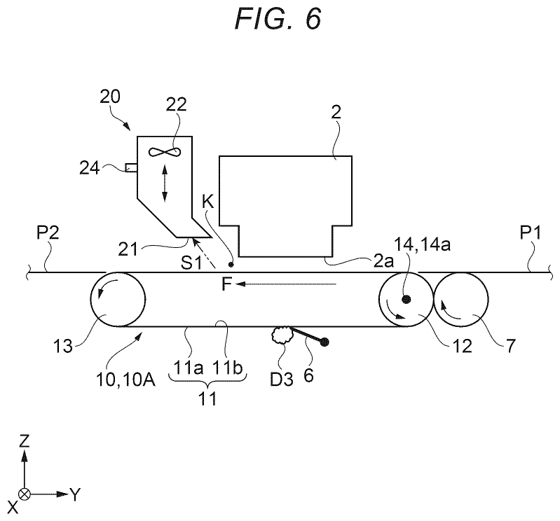

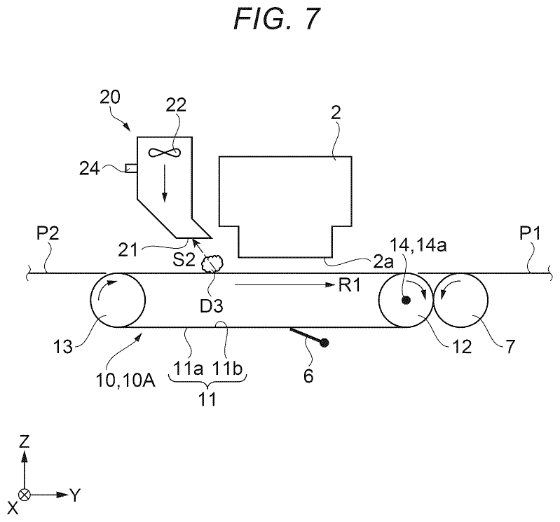

As illustrated in FIGS. 6 and 7, the recording apparatus 1 includes a charging roller 7 capable of charging electric charges and a blade 6 capable of coming into contact with the belt 11. The duct 20 includes an air flow port lifting and lowering unit 24.

As explained above with reference to FIG. 3, the support unit 10 is rotatable centering on the rotation shaft 14a by the rotating unit 14. The duct 20 generates the first ejection air flow B1 when the support unit 10 moves to the second position 10B and when the support unit 10 moves to the first position 10A. In FIGS. 6 and 7, the support unit 10 is present at the first position 10A.

As illustrated in FIG. 6, the first roller 12 and the second roller 13 of the support unit 10 rotate counterclockwise and come into contact with an inner peripheral surface 11b of the belt 11 to cause the belt 11 to turn around counterclockwise. The medium M is placed on an outer peripheral surface 11a of the belt 11 by the support unit 10 present at the first position 10A, conveyed in the conveyance direction F, and recorded by the head 2.

At this time, the outer peripheral surface 11a of the belt 11 of the rotating support unit 10 is charged by receiving electric charges while being in contact with the rotating charging roller 7. In the following explanation, the belt 11 shall indicate the outer peripheral surface 11a of the belt 11.

The charged belt 11 can attract the medium M with static electricity and can accurately convey the medium M. The distance between the medium M attracted to the belt 11 and the ink discharge surface 2a of the head 2 can be fixed and recording quality can be improved. Such a charged belt 11 is also called electrostatic attraction belt.

At this time, the duct 20 generates the first suction air flow S1 to suck the ink mist K.

The charged belt 11 can also attract, with static electricity, the first dust D1, the second dust D2, and the like floating in the air and can also prevent these dusts, which are foreign matters, from adhering to the ink discharge surface 2a of the head 2.

On the other hand, these dusts attracted to the belt 11 are likely to hinder the attraction of the medium M to the belt 11 and deteriorate conveyance accuracy. In addition, these dusts are likely to change the distance between the medium M and the ink discharge surface 2a of the head 2, also change a situation in which the ink lands on the medium M, and deteriorate recording quality.

Therefore, as illustrated in FIG. 6, the blade 6 comes into contact with the lower belt 11 on which the medium M is not placed and scrapes off and removes these dusts that move together with the belt 11. The removed dusts are deposited as third dust D3 on the distal end side of the blade 6, which is a side in contact with the belt 11. The blade 6 is movable together with the support unit 10 by the rotating unit 14.

The third dust D3 deposited on the blade 6 will be rubbed by the turning belt 11. The third dust D3 contains powder dust, paper dust, and the like and, when solidified, is likely to damage and deteriorate the belt 11.

Thus, as illustrated in FIG. 7, the duct 20 sucks and removes the third dust D3 on the belt 11. Specifically, the recording apparatus 1 operates as follows.

First, the first roller 12 and the second roller 13 of the support unit 10 rotate clockwise and reversely rotate and return the belt 11 in an opposite direction R1, which is the direction opposite to the conveyance direction F. The medium M is not placed on the belt 11. At this time, the third dust D3 adheres to the belt 11 and moves in the opposite direction R1 together with the belt 11. When the position of the belt 11 to which the third dust D3 adheres reaches a position below the air flow port 21 of the duct 20 and facing the air flow port 21, the belt 11 stops.

The duct 20 can function as a suction, generate the second suction air flow S2, and suck and remove the third dust D3 adhering to the belt 11.

As illustrated in FIG. 7, when the duct 20 sucks the third dust D3, the air flow port 21 is preferably brought close to the third dust D3 on the belt 11. Further, the duct 20 preferably moves the air flow port 21 to a position in contact with the belt 11. The duct 20 can effectively suck the third dust D3 on the belt 11 from the air flow port 21.

The air flow port lifting and lowering unit 24 is capable of moving the position of the air flow port 21 of the duct 20 up and down with respect to the position of the belt 11. When the duct 20 sucks the third dust D3, the air flow port lifting and lowering unit 24 preferably moves the air flow port 21 downward to approach the belt 11. Alternatively, the air flow port lifting and lowering unit 24 may move the air flow port 21 to a position in contact with the belt 11.

When the duct 20 and the air flow port 21 are integrally configured, the air flow port 21 can be lowered by the air flow port lifting and lowering unit 24 lowering the duct 20.

The duct 20 can effectively suck the third dust D3 on the belt 11 from the air flow port 21 with the air flow port lifting and lowering unit 24.

As a result, the third dust D3 deposited on the blade 6 is removed and it is possible to prevent the belt 11 from being damaged and deteriorated.

The duct 20 may change the rotating speed of the fan 22 by the fan motor with respect to the first suction air flow S1 and change the strength of the air flow sucked by the second suction air flow S2. For example, the duct 20 may make the air flow of the second suction air flow S2 stronger than the first suction air flow S1.

The duct 20 is capable of switching at least generation of one of the first suction air flow S1 and the second suction air flow S2 and generation of the first ejection air flow B1.

After the duct 20 sucks the third dust D3 of the belt 11 with the second suction air flow S2, the air flow port lifting and lowering unit 24 moves the air flow port 21 upward and returns the air flow port 21 to the original position thereof.

As explained above, the recording apparatus 1 includes the head 2 that performs recording on the medium M, the support unit 10 capable of supporting the medium M, and the rotating unit 14 that moves the support unit 10 between the first position 10A facing the head 2 and the second position 10B separated from the head 2.

Furthermore, the recording apparatus 1 includes the duct 20 that at least generates the first ejection air flow B1 in the direction from the head 2 toward the position of the support unit 10 present at the first position 10A in the period in which the support unit 10 moves toward the first position 10A or the second position 10B.

The recording apparatus 1 having the configuration explained above can move, with the first ejection air flow B1, dust such as the first dust D1 and the second dust D2, which is about to rise and scatter toward the ink discharge surface 2a of the head 2, away from the ink discharge surface 2a.

As a result, when the support unit 10 including the belt 11 moves, it is possible to prevent such dust from adhering to the head 2 to cause a malfunction.

The embodiments are explained in detail above with reference to the drawings. However, specific components are not limited to those in the embodiments and may be, for example, changed, and replaced without departing from the gist of the disclosure.

In the above explanation, the head 2 is explained as an example of the line type inkjet head but may be a serial type ink jet head mounted on a carriage.

In the above explanation, the rotating unit 14 and the rotation shaft 14a of the support unit 10 are provided on the first roller 12 side upstream in the conveyance direction F but may be provided on the second roller 13 side downstream. The support unit 10 can be rotated clockwise centering on the rotation shaft 14a by the rotating unit 14 and move from the first position 10A to the second position 10B.

In the second embodiment explained above, when the duct 20 is caused to function as a blower, the wind direction of the second ejection air flow B2 is changed by the air flow port moving unit 23. In the second embodiment as well, the air flow port lifting and lowering unit 24 explained in the third embodiment may be provided and, when the duct 20 is caused to function as a blower, the position in the up-down direction of the air flow port 21 may be changed.

In the third embodiment explained above, when the third dust D3 adhering to the belt 11 of the support unit 10 is sucked by the duct 20, the position in the up-down direction of the air flow port 21 is changed by the air flow port lifting and lowering unit 24.

In the third embodiment, the air flow port moving unit 23 explained in the second embodiment may be provided instead of the air flow port lifting and lowering unit 24. The air flow port moving unit 23 enables the air flow port 21 to approach and separate from the belt 11 while drawing an arc.

In the above explanation, the position of the air flow port 21 of the duct 20 is above the belt 11 and on the downstream side in the conveyance direction F with respect to the head 2. The position of the air flow port 21 may be on the upstream side of the head 2, may be a lateral position such as the left or the right of the head 2, or may be below the belt 11 of the support unit 10. A plurality of air flow ports 21 may be provided. In this case, the duct 20 may generate a suction air flow in order to move dust away from the head 2.

Although the first dust D1 and the second dust D2 are explained above as examples of dust, the same applies to dust other than the first dust D1 and the second dust D2 present in the case 5.

What is claimed is:

1. A recording apparatus comprising:
a recording unit configured to perform recording on a medium;
a support unit capable of supporting the medium;
a moving unit configured to move the support unit between a first position facing the recording unit and a second position separated from the recording unit; and
an air flow generation unit configured to generate at least an ejection air flow in a direction from the recording unit toward a position of the support unit present at the first position in a period in which the support unit moves toward the first position or the second position.

2. The recording apparatus according to claim 1, wherein the air flow generation unit includes an air blowing unit and is located above the support unit present at the first position.

3. The recording apparatus according to claim 2, wherein
the recording unit is a liquid discharge unit, and
the air flow generation unit is capable of, by switching an operation of the air blowing unit, switching at least generation of the ejection air flow and a suction air flow that sucks mist that occurs when the liquid discharge unit discharges.

4. The recording apparatus according to claim 2, wherein
the air flow generation unit includes an air flow port that ejects the ejection air flow and includes an air flow port moving unit that changes a direction of the air flow port, and
the air flow port moving unit changes the direction of the air flow port to a direction toward the recording unit in a period in which the support unit moves from the first position to the second position and changes the direction of the air flow port to a direction toward the position of the support unit present at the first position in a period in which the support unit moves from the second position to the first position.

5. The recording apparatus according to claim 1, wherein the support unit includes a conveyance belt capable of conveying the medium placed thereon.

6. The recording apparatus according to claim 5, wherein
the air flow generation unit includes an air flow port that ejects the ejection air flow and includes a blade that comes into contact with the conveyance belt and scrapes off foreign matters and an air flow port lifting and lowering unit that moves a position of the air flow port of the air flow generation unit up and down,
the support unit causes a position of the conveyance belt, to which the foreign matters adhere, to reach a position facing the air flow port,
the air flow port lifting and lowering unit causes the air flow port to approach the conveyance belt to which the foreign matters adhere, and
the air flow generation unit generates a suction air flow, which sucks the foreign matters, to suck the foreign matters adhering to the conveyance belt.

7. The recording apparatus according to claim 5, further comprising a charging roller configured to charge electric charges, wherein
the conveyance belt of the support unit comes into contact with the rotating charging roller, is charged by receiving the electric charges, and is capable of attracting foreign matters on the medium and in the air.
